(19) United States
(12) Patent Application Publication
(10) Pub. No.: US 2008/0063486 A1
(43) Pub. Date: Mar. 13, 2008

(54) Commuter Car Trailer

(76) Inventor: Sudhamshu Reddy Beeravolu, South Pasadena, CA (US)

Correspondence Address: Sudhamshu Reddy Beeravolu, 1700 Huntington Dr, Apt #1, South Pasadena, CA, 91030, US

(21) Appl. No.: 11/851,644

(22) Filed: Sep. 7, 2007

Related U.S. Application Data
(60) Provisional application No. 60/824,906, filed on Sep. 8, 2006.

(51) Int. Cl. B60P 3/07; B60K 28/14; B60P 3/073; B62D 63/06; H02J 7/00

(52) U.S. Cl. 410/3; 180/271; 180/274; 280/400; 280/411.1; 320/137; 410/19

(57) ABSTRACT

This invention describes a commuter car trailer. A commuter car is a significantly smaller vehicle compared to the average sized car in the United States. A commuter car trailer efficiently and safely transports commuter cars, and can do so with the driver still in the commuter car. The commuter car trailer may be attached and towed by a vehicle capable of pulling the weight of the commuter car trailer and commuter cars carried by the commuter car trailer. It is also possible to have a vehicle with a commuter car trailer permanently attached to its frame. In addition to many safety features, the commuter car trailer also offers a numerous conveniences for the operator of the commuter car trailer and for commuter car owners being carried by the commuter car trailer.

This application claims the benefit of and priority of U.S. Provisional Patent Application Ser. No. 60/824,906, entitled “Commuter Car Trailer” by Sudhamshu Reddy Beeravolu, filed on Sep. 8, 2006.

### BACKGROUND OF THE INVENTION

1. Field of the Invention

The present invention relates generally to an automotive trailer, and more particularly, to an automotive trailer for carrying commuter cars.

2. Description of the Related Art

The regular car hauler is designed to carry regular cars—one, two or more, depending upon the size of the hauler. This is built with a frame and a deck fitted on it.

At the front of the frame, a hinge is provided to latch it to the towing vehicle. It has one, two or more sets of wheels, near to the center, depending upon the size of the hauler. There is a provision for ramps at the rear to facilitate movement of car/s up/down the hauler.

The regular car hauler is also provided with mount jack to rest on when parked. Optionally, it is provided with Axles, Idler and Brake systems. A basic Leaf Spring or other kind of suspension is fitted for smoother ride for the towed cars.

The regular car hauler is equipped with flush mount lights and either a manual or electrically operated Breakaway systems to latch/unlatch it from the towing vehicle as necessary.

### SUMMARY OF THE INVENTION

The present invention is for a commuter car trailer. A commuter car trailer provides a convenient and safe method for transporting commuter cars. Special consideration has been given to the safety since the commuter car trailer is capable of transporting a commuter car while a person is inside the commuter car. The commuter car trailer also provides many features and efficiencies for the operator of the commuter car trailer.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a block diagram, showing the top view of a commuter car trailer latched onto a vehicle towing the commuter car trailer.

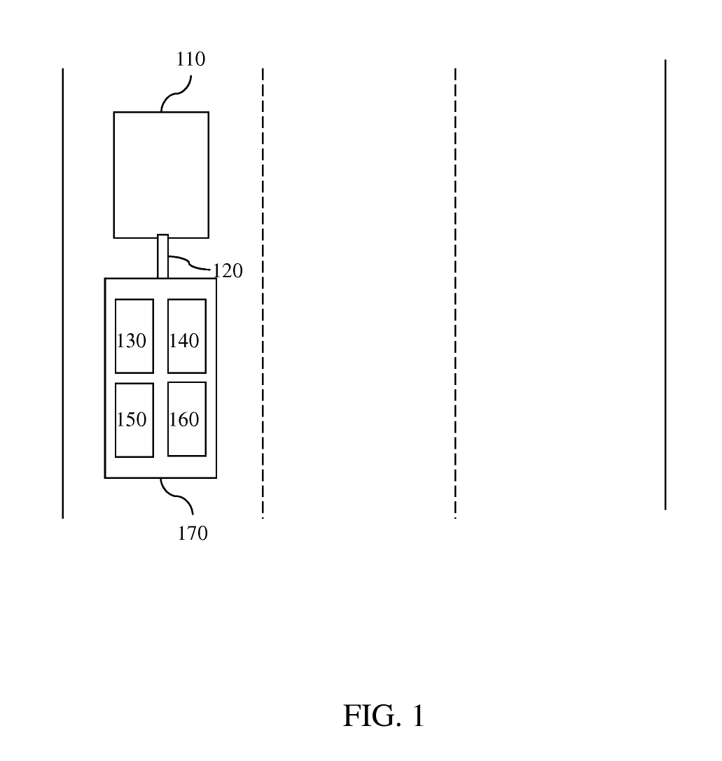

FIG. 2 is side view of a commuter car trailer latched onto a vehicle towing the commuter car trailer.

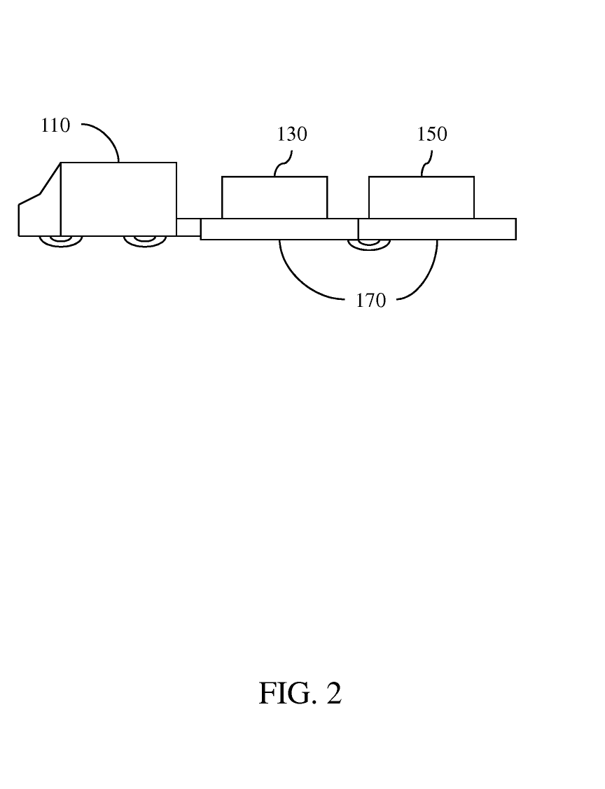

FIG. 3 is a top view of a commuter car trailer with four commuter cars on it.

FIG. 4 is a top view of a commuter car trailer with two commuter cars on it.

FIG. 5 is a side view of a parked vehicle, where the commuter car trailer is collapsed.

FIG. 6 is a side view of a commuter car trailer, with ramp to allow commuter cars to be driven on and off the trailer.

FIG. 7 is a rear view of a commuter car trailer.

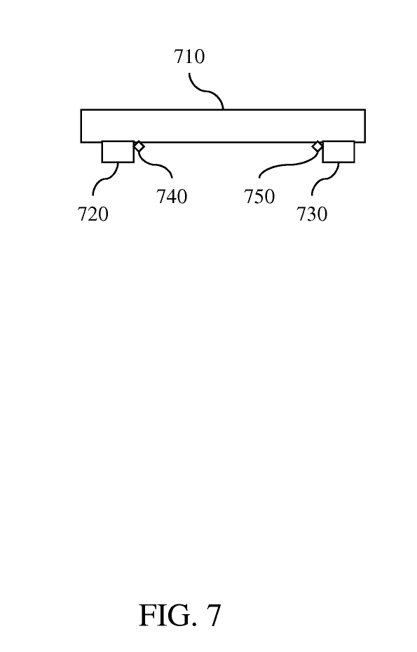

FIG. 8 is a side view of a commuter car trailer with crash shock absorption systems.

FIG. 9 is a side view of a commuter car trailer with a crash shock absorption system.

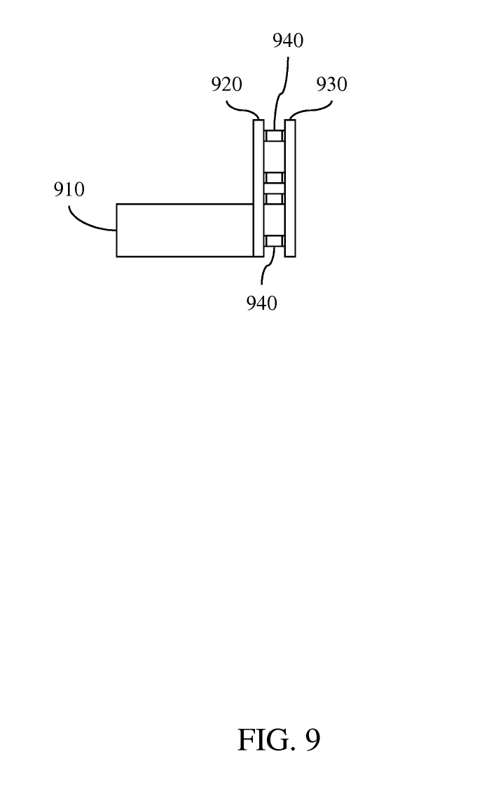

FIG. 10 is a side view of a commuter car trailer with an airbag system.

FIG. 11 is a side view of a commuter car trailer with rectangle frames for restraining commuter cars.

FIG. 12 is a rear view of a commuter car trailer with rectangle frames for restraining commuter cars.

FIG. 13 is a side view of a commuter car trailer with a tire grip system.

FIG. 14 is a side view of a commuter car trailer with a tire holder system.

FIG. 15 is a rear view of a commuter car trailer system with a sign attached.

FIG. 16 is a side view of a truck with an integrated commuter car trailer.

FIG. 17 is a front view of a commuter car parking system with parked regular and commuter car.

FIG. 18 is a side view of a commuter car parking system.

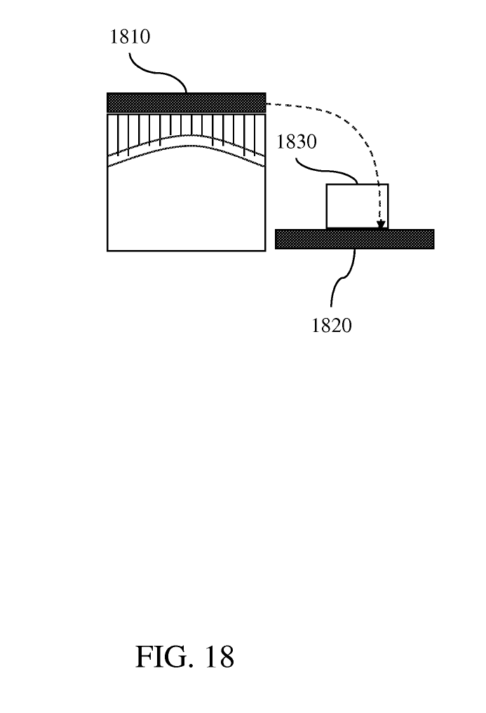

FIG. 19 is a front view of a commuter car parking system.

FIG. 20 is a front view of a commuter car parking system with a lightweight covering on top.

FIG. 21 is a rear view of a commuter car with a movable weight balance.

### DETAILED DESCRIPTION

A commuter car trailer 170 is a trailer capable of carrying Commuter Cars 130 140 150 160. Descriptions of a Commuter Car are provided below, along with descriptions of a commuter car trailer.

A Commuter Car may be electric, hybrid, regular engine cars and/or other commuter vehicles thereof, with or without the Commuter Car's driver and/or passenger sitting inside it. The Commuter Cars 130 140 150 160 are typically smaller than a conventional car, and can seat one to two individuals. Commuter Cars 130 140 150 160 are sleek, meaning, usually they are considerably less in width in comparison to the regular cars—some being almost half the width of the regular car. A Commuter Car is usually powered by a regular ICE (Internal Combustion Engine) or electric or any kind of hybrid technology.

Commuter car trailers 170 are designed to facilitate towing by a regular/standard car/truck 110 and/or customized truck 1650. The commuter car trailer can be optionally integrated/customized to fit regular truck chassis or other provided/available structure thereof, on a permanent or temporary basis.

The commuter car trailer 170 in conjunction with the Commuter Cars 130 140 150 160 are usually used for the regular point-to-point commute purpose.

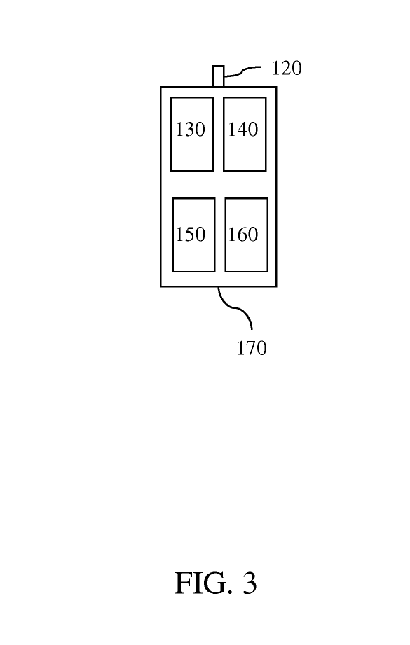

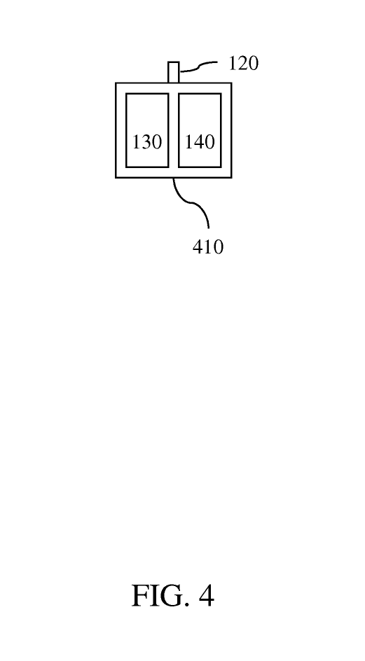

Typically, as seen in FIG. 3, a commuter car trailer 170 can fit in two Commuter Cars 130 140 in one row. The commuter car trailer 170, which is connected to the regular car/truck by a regular or customized latch 120, is extendable and collapsible. The commuter car trailer can be extended in all directions—horizontal, vertical and top. FIG. 4 shows a small commuter car trailer 410 which can be latched 120 on to another commuter car trailer, thus allowing for extensibility. The commuter car trailer 410 is a single-row-two-column version. This would accommodate two Commuter Cars 130 140 in parallel, i.e., side-by-side in one row. This can be extended by attaching a similar single-row-two-column version to it, making it a two-row-two-column version. In a similar fashion, it can be extended in all possible directions as needed, horizontally, vertically, and by stacking up.

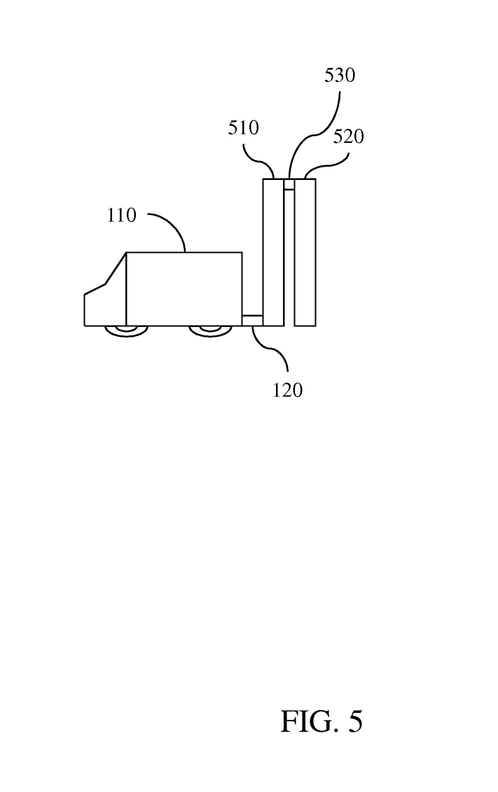

FIG. 5 shows a truck 110 parked and latched 120 on to a commuter car trailer 510 520. The commuter car trailer 510 520 has no Commuter Cars on it, and is collapsed for convenience. It is possible to optionally fold and collapse the commuter car trailer 510 520 row at the joiner 530. This action of folding/collapsing can be done automatically with a push of a button. By doing so, the parked commuter car trailer 510 520 saves space. The commuter car trailer can be completely folded into the trunk of the truck.

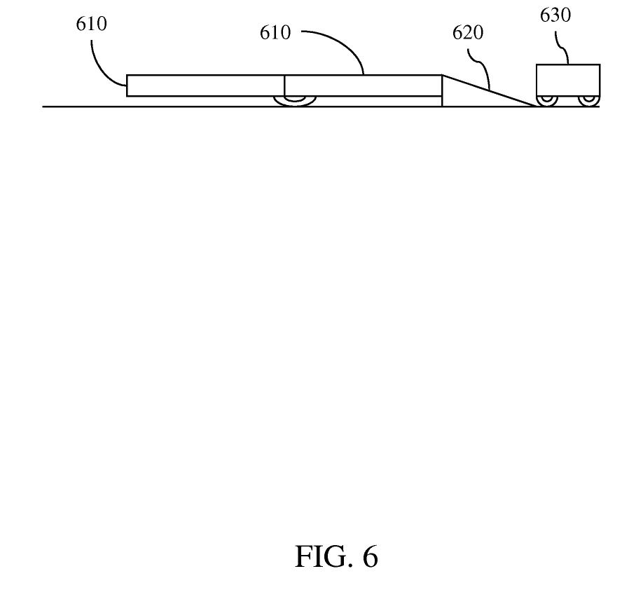

As seen in FIG. 6, a Commuter Car 630 can drive up and down the commuter car trailer 610 or it can be provisioned to be automatically loaded/unloaded on to the commuter car trailer 610. A drive up-down ramp 620 can be provided at the back of the commuter car trailer 610 for the Commuter Car 630 to drive up and down. This drive up-down ramp 620 can automatically be folded onto the commuter car trailer 610 once the Commuter Car 630 is loaded/unloaded from the commuter car trailer 610. Optionally, the commuter car trailer 610 can be designed to tilt backwards so that the Commuter Car 630 can drive up-down the commuter car trailer 610 instead of the ramp system 620.

The commuter car trailer 710 is designed so as to maintain the normal travel comfort for passengers/driver seated within the Commuter Car when the Commuter Car is loaded and being towed by the commuter car trailer 710. This comfort is achieved by providing the required shock absorbers 740 750 for the commuter car trailer 710 frame at the required points.

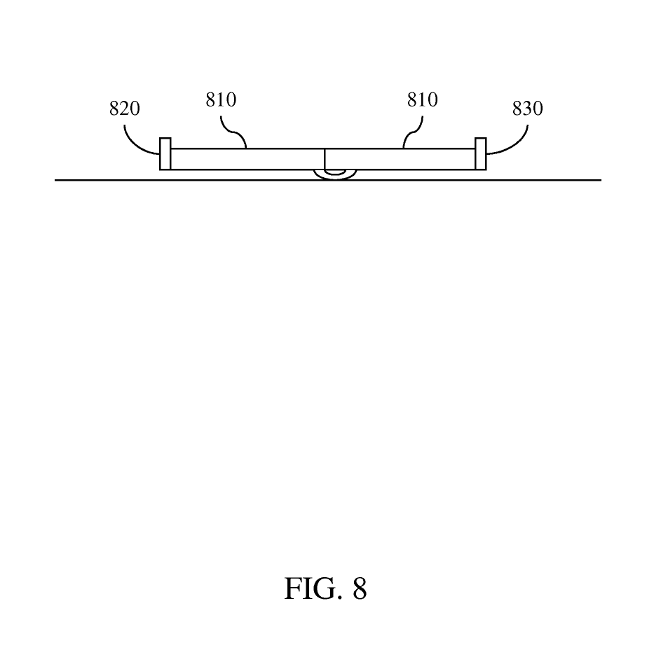

Safety is an important aspect of the commuter car trailer. FIG. 8 shows a commuter car trailer 810 with a shock absorption mechanism at the front 820 and back 830. These shock absorption mechanisms 820 830 can help reduce the impact to the Commuter Cars in case of a collision. Such a shock absorption system 820 830 can be achieved by joining two strong metal sheets 920 930, with shock absorbers 940 in between.

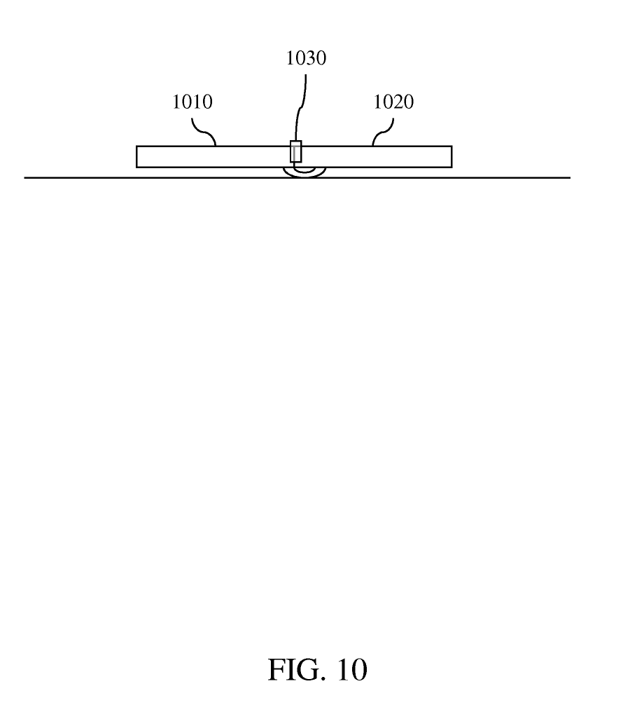

FIG. 10 shows a commuter car trailer 1010 1020 with an airbag system 1030. Between each row of a commuter car trailer 1010 1020, an airbag can be provided to reduce the damage incurred by the Commuter Cars during impact. The airbags would pop open in case of a collision. This would prevent direct impact of the Commuter Cars with one another.

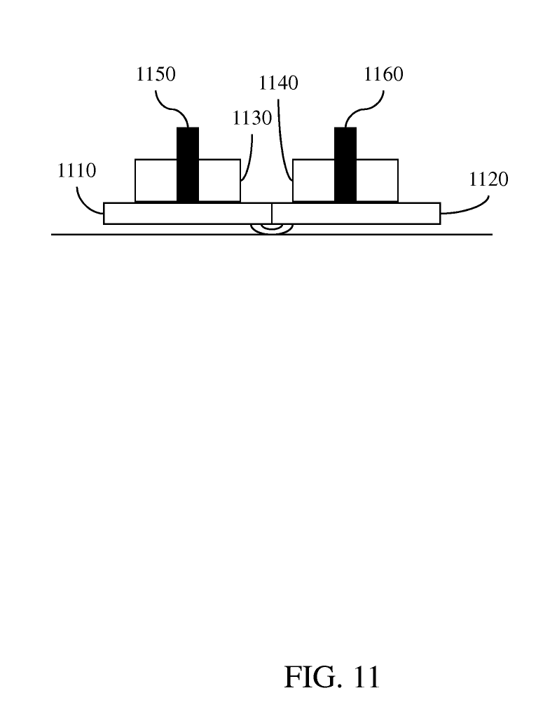

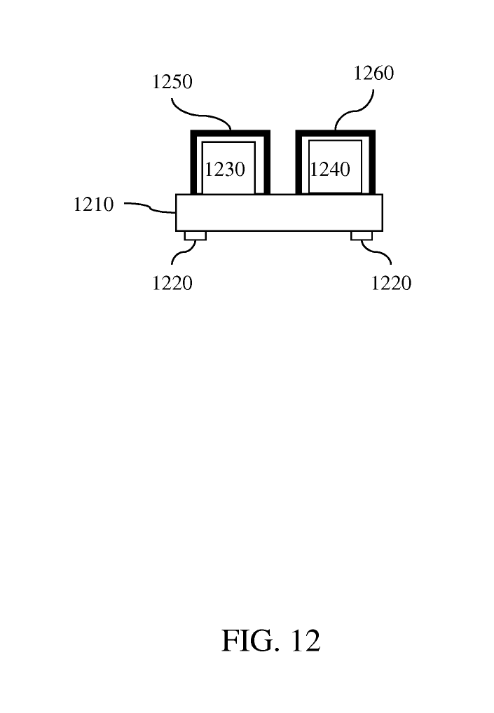

FIG. 11 shows a commuter car trailer 1110 1120 equipped with rectangular frames 1150 1160, covering each of the Commuter Cars 1130 1140. These frames 1150 1160 would prevent the Commuter Cars 1130 1140 from bouncing off the commuter car trailer 1110 1120 in case of a collision. These rectangular frames 1150 1160 can be folded up and down automatically, with the push of a button. FIG. 12 shows a rear view of a commuter car trailer 1210 with rectangular frames 1250 1260. Rectangular frame 1250 is used to keep Commuter Car 1230 in place, and rectangular frame 1260 is used to keep Commuter Car 1240 in place.

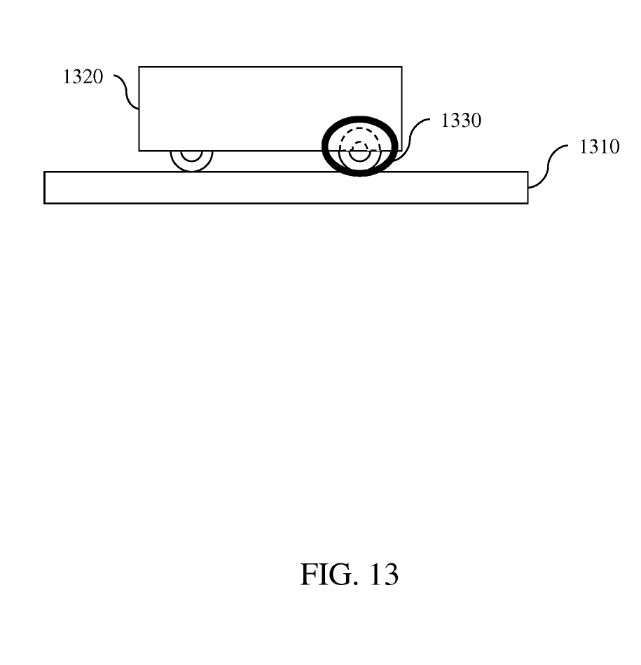

FIG. 13 shows a commuter car trailer 1310 with a Commuter Car tire grip mechanism 1330. The tire grip mechanism 1330 serves the purpose of keeping the Commuter Car 1320 in place, and prevents the Commuter Car 1320 from bouncing/jumping off of the commuter car trailer 1310.

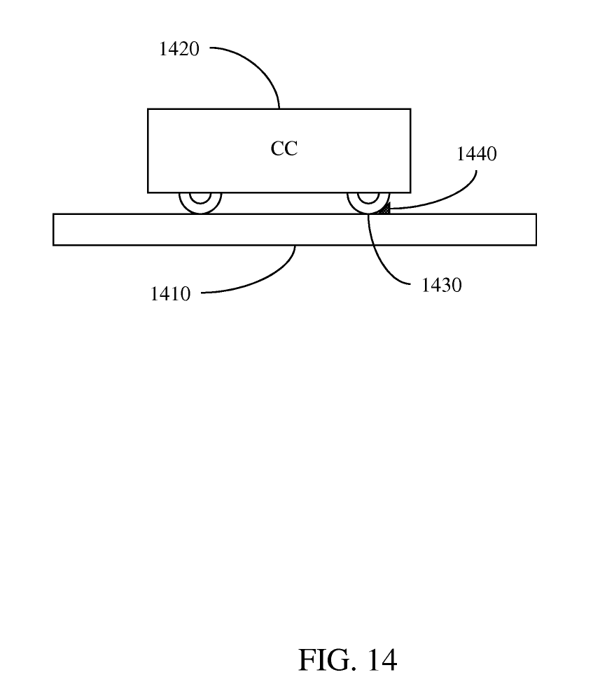

FIG. 14 is a commuter car trailer 1410 with a tire holder 1440. The tire holder 1440 can be automatically placed once the Commuter Car's 1420 wheel 1430 is placed in the proper position on the commuter car trailer 1410.

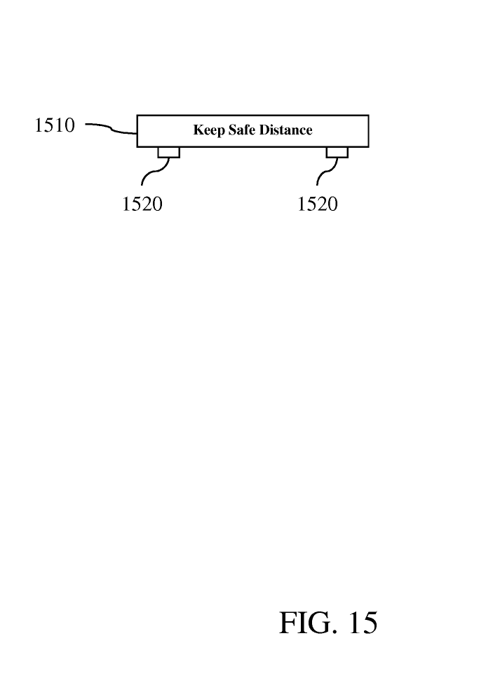

FIG. 15 shows a rear view of a commuter car trailer 1510 with two wheels 1520. The commuter car trailer 1510 has a sign, warning other vehicle driving behind it to “Keep Safe Distance” for safety purposes. Other words or images can be placed on the commuter car trailer 1510 for safety or advertising purposes.

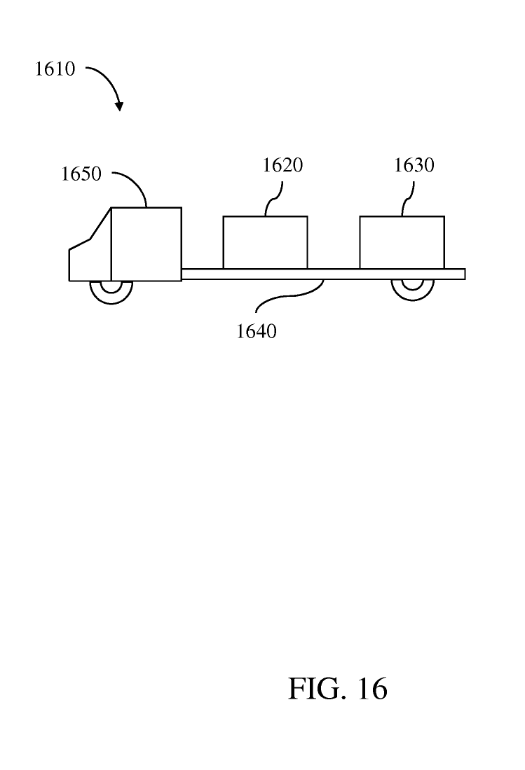

FIG. 16 shows a commuter car trailer 1640 that is integrated with a regular truck 1650 chassis. The truck 1610 can be customized to integrate the commuter car trailer 1640 or to completely merge the commuter car trailer 1640 to the truck 1610.

The process of building a commuter car trailer for the preferred embodiment of this invention is described below.

Fabricate 100 inches width×120 inches (240 inches for double car) length steel frame.

Fit a metal or wood deck on to it.

Provide for two small car drive up lanes (in parallel) as opposed to one in case of regular car hauler.

Fit it with one or two wheel sets/systems on either side, under the frame. This is to gain more width.

The wheels are provided with the best of the brake systems like hydraulic. This is to make sure that the commuters seated in the commuter cars are provided with highest level of safety.

This commuter car trailer/hauler is provided with the best of suspension systems to provide for comfortable and smooth ride for the commuters sitting inside the commuter cars.

Safety is an important aspect of the commuter car trailer. FIG. 8 shows a commuter car trailer 810 with a shock absorption mechanism at the front 820 and back 830. These shock absorption mechanisms 820 830 can help reduce the impact to the Commuter Cars in case of a collision. Such a shock absorption system 820 830 can be achieved by joining two strong metal sheets 920 930, with shock absorbers 940 in between.

Charging system—As the commuter cars are switched off, provision is made for charging the battery of the commuter cars from the running towing car wherein the Air conditioning, radio and other systems can be used by the commuters in the commuter cars.

It is possible to optionally fold and collapse the commuter car trailer 510 520 row at the joiner 530. This action of folding/collapsing can be done automatically with a push of a button. By doing so, the parked commuter car trailer 510 520 saves space. The commuter car trailer can be completely folded into the trunk of the truck.

The commuter car trailer 710 is designed so as to maintain the normal travel comfort for passengers/driver seated within the Commuter Car when the Commuter Car is loaded and being towed by the commuter car trailer 710. This comfort is achieved by providing the required shock absorbers 740 750 for the commuter car trailer 710 frame at the required points.

A drive up-down ramp 620 can be provided at the back of the commuter car trailer 610 for the Commuter Car 630 to drive up and down. This drive up-down ramp 620 can automatically be folded onto the commuter car trailer 610 once the Commuter Car 630 is loaded/unloaded from the commuter car trailer 610. Optionally, the commuter car trailer 610 can be designed to tilt backwards so that the Commuter Car 630 can drive up-down the commuter car trailer 610 instead of the ramp system 620.

FIG. 10 shows a commuter car trailer 1010 1020 with an airbag system 1030. Between each row of a commuter car trailer 1010 1020, an airbag can be provided to reduce the damage incurred by the Commuter Cars during impact. The airbags would pop open in case of a collision. This would prevent direct impact of the Commuter Cars with one another.

FIG. 11 shows a commuter car trailer 1110 1120 equipped with rectangular frames 1150 1160, covering each of the Commuter Cars 1130 1140. These frames 1150 1160 would prevent the Commuter Cars 1130 1140 from bouncing off the commuter car trailer 1110 1120 in case of a collision. These rectangular frames 1150 1160 can be folded up and down automatically, with the push of a button. FIG. 12 shows a rear view of a commuter car trailer 1210 with rectangular frames 1250 1260. Rectangular frame 1250 is used to keep Commuter Car 1230 in place, and rectangular frame 1260 is used to keep Commuter Car 1240 in place.

FIG. 13 shows a commuter car trailer 1310 with a Commuter Car tire grip mechanism 1330. The tire grip mechanism 1330 serves the purpose of keeping the Commuter Car 1320 in place, and prevents the Commuter Car 1320 from bouncing/jumping off of the commuter car trailer 1310.

FIG. 14 is a commuter car trailer 1410 with a tire holder 1440. The tire holder 1440 can be automatically placed once the Commuter Car's 1420 wheel 1430 is placed in the proper position on the commuter car trailer 1410.

At the front of the frame, a hinge is provided to latch it to the towing vehicle.

The commuter car trailer/hauler is provided with mount jack to rest on when parked.

The commuter car trailer/hauler is equipped with flush mount lights and either a manual or electrically operated Breakaway systems to latch/unlatch it from the towing vehicle as necessary.

FIG. 15 shows a rear view of a commuter car trailer 1510 with two wheels 1520. The commuter car trailer 1510 has a sign, warning other vehicle driving behind it to “Keep Safe Distance” for safety purposes. Other words or images can be placed on the commuter car trailer 1510 for safety or advertising purposes.

FIG. 16 shows a commuter car trailer 1640 that is integrated with a regular truck 1650 chassis. The truck 1610 can be customized to integrate the commuter car trailer 1640 or to completely merge the commuter car trailer 1640 to the truck 1610.

Once Commuter Cars and commuter car trailers become popular, there will be coordination systems for bringing together owners with Commuter Cars with commuter car trailers. One possible coordination system is a Commuter Network System. A Commuter Network System includes one or more centralized call receiving center, which receives calls from the interested individuals who wants to be part of the Commuter Network System. The process of the Commuter Network System includes, but is not limited to, receiving calls from the interested individuals, selling and/or renting and/or leasing and/or integrating the commuter car trailer, coordinating with the Commuter Car and/or commuter car trailer owners to facilitate easier and better daily commute to the workplace and back by matching their needs. The Commuter Network System would optionally provide a point-to-point transport for Commuter Car drivers via commuter car trailers. These commuter car trailers may be owned by the Commuter Network System or by a third party. The commuter car trailers are provided with Global Positioning System to locate their movement.

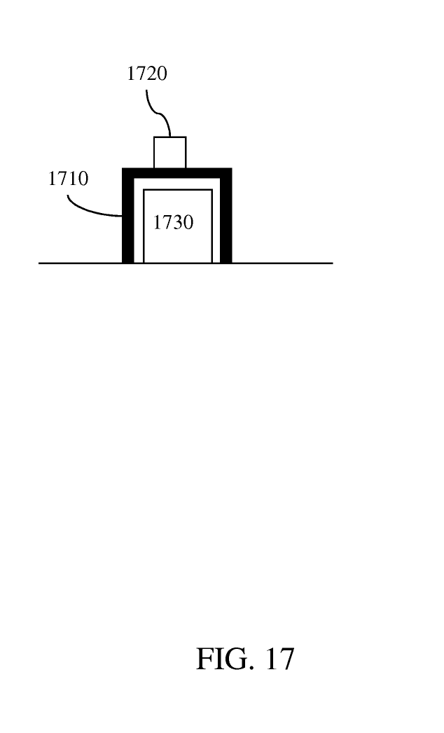

Commuter Car owners will desire a better parking system for their Commuter Cars. The Commuter Car Parking System, as shown in FIG. 17 provides parking for the Commuter Car, or any other car, one level higher than the existing parking space. The Commuter Car Parking System is comprised of a sturdy, hydraulically driven steel frame, which can be fitted into an existing parking space, whether covered or open. Different structures are designed depending on the suitability of the parking space. FIG. 17 shows a Commuter car 1720, parked above a regular car 1730 through the use of the Commuter Car Parking System 1710.

The top section 1810 1820 of the Commuter Car Parking System can be hydraulically moved up and down with the push of a button. When the top section comes down 1820, the Commuter Car 1830 can be driven onto it. There after, the top section can be moved back up 1810, lifting along with it, the parked Commuter Car 1830. The movement of the top section is angular, or arched, to allow for the parking of the Commuter Car 1830, even when there is a regular car parked inside the Commuter Car Parking System.

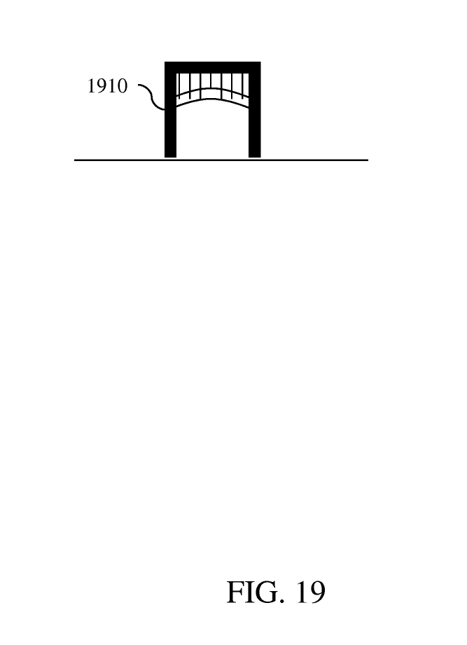

The Commuter Car Parking System is designed to carry and handle the weight of the Commuter Car throughout the whole process by proving required weight balancing structures in it, as seen in FIG. 19.

This Commuter Car Parking System would be very useful in existing apartment complexes, where parking space is very limited. All of the other possible provisions would be included to secure the safety of this system. For example, a bumpy surface with high traction may be provided on the top section 1810 1820 to prevent the Commuter Car 1830 from sliding down and falling after it has been lifted on to the top. In addition, tire holders may also be used to serve additional safety.

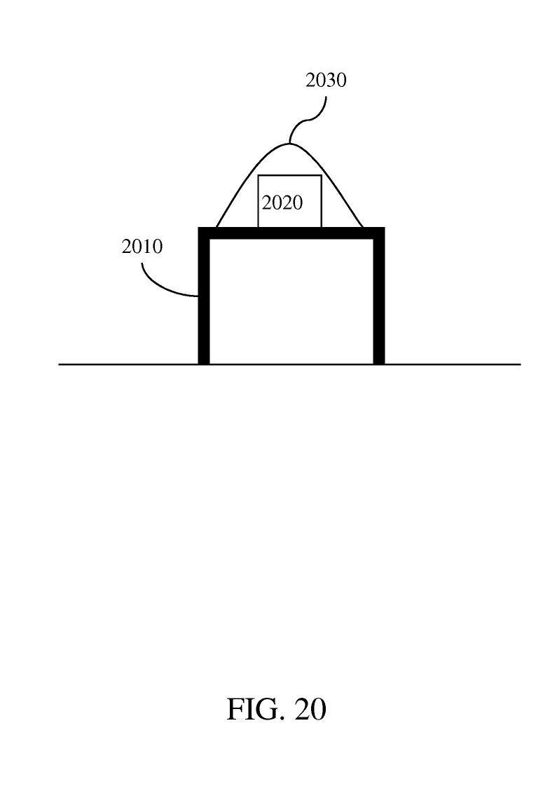

Optionally, the top section of the Commuter Car Parking System can be provisioned to have a lightweight covering 2030 as shown in FIG. 20.

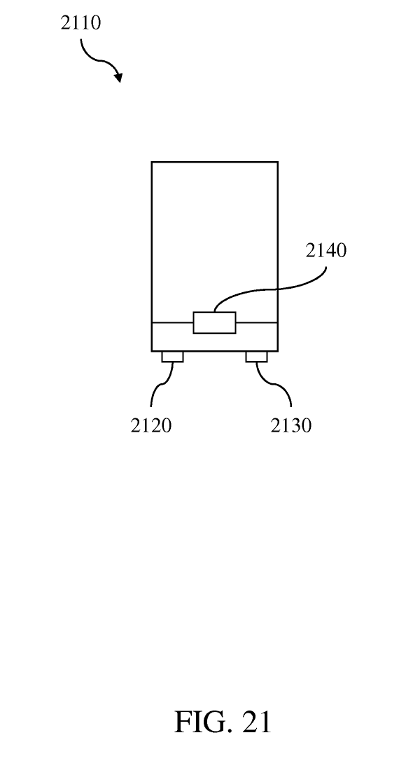

FIG. 21 shows a Commuter Car 2110, using a balancing technology 2140. A Commuter Car 2110 having four wheels 2120 2130, being less in width has a higher probability of tipping or rolling over when taking tight turns. This balancing technology 2140 is used to keep balance in these situations. This balancing technology provides a balancing weight at the center 2140 of the car, which moves side-ways depending upon the speed and the angle of turn of the car. For example, the weight would move to the left when the car moves to the left when making a left turn to keep the center of gravity at the center of the vehicle and similarly it moves to the right when making a right turn. The movement of the weight also depends upon the speed with which it takes a turn. For example, if the car turns to its left at a speed of 20 mph, the weight would move less to its left when compared to when car turns at 40 mph.

The weight is placed at the lowest possible level in the car which technically speaking would provide the best balance.

This system is computer controlled, power driven and set to the maximum precision, facilitating driver the optimum control over the car.

Although the present invention has been described in detail with respect to certain embodiments and examples, variations and modifications exist which are within the scope of the present invention as defined in the following claims.

What is claimed:

1. A trailer for transporting commuter cars comprising:
a main frame;
a plurality of wheels attached to said main frame;
a primary deck attached to said main frame, said primary deck capable of holding commuter cars side-by-side; and
a ramp allowing for said commuter cars to drive up and down from said primary deck.

2. A trailer as defined in claim 1, further comprising a regular truck, wherein said trailer is integrated with the chassis of said regular truck for permanent attachment.

3. A trailer as defined in claim 1, further comprising a means for attaching additional trailers for transporting commuter cars to said trailer.

4. A trailer as defined in claim 1, further comprising a means for folding.

5. A trailer as defined in claim 1, further comprising of a shock absorption mechanism placed in front of and behind said commuter cars.

6. A trailer as defined in claim 1, further comprising of an airbag system to reduce impact of additional commuter cars behind said commuter cars in the event of a collision.

7. A trailer as defined in claim 1, further comprising of rectangular frames, where in the event of a collision, said rectangular frames prevent said commuter cars from bouncing off said trailer.

8. A trailer as defined in claim 1, further comprising of a tire grip mechanism.

9. A trailer as defined in claim 1, further comprising of a charging system for charging said commuter cars' batteries.
